(19) United States
(12) Patent Application Publication
(10) Pub. No.: US 2005/0159495 A1
(43) Pub. Date: Jul. 21, 2005

(54) Toluene diisocyanate tar fluidizer and method of use

(76) Inventors: William J. Jennings, Brooklyn, NY (US); John H. Roberts, Rye, NY (US); John Nikles, Findlay, OH (US)

Correspondence Address: WILLIAM R. MORAN, SUITE 909, 333 EAST 43RD STREET, NEW YORK, NY, 10017, US

(21) Appl. No.: 10/760,871

(22) Filed: Jan. 20, 2004

(51) Int. Cl. C08J 11/04

(52) U.S. Cl. 521/40; 252/364; 208/45; 210/773

(57) ABSTRACT

A fluidizer composition is provided which is useful in fluidizing residual tar bottoms from conventionally manufactured TDI in order to increase the recovery of the more expensive TDI monomer. The benefits for using the fluidizer composition are disclosed.

### BACKGROUND OF THE INVENTION

1) Field of the Invention

This invention relates to a fluidizer composition for solvating toluene diisocyanate tars formed during the conventional method for preparing toluene diisocyanate monomer and for enhanced TDI monomer recovery.

2) Background Art

Toluene diisocyanate, hereinafter also referred to as “TDI”, is a monomer produced in large volumes at world scale facilities. The process for making TDI monomer is generally the phosgenation of toluene diamine. Manufactured monomer is subsequently removed by a series of vapor/liquid separations leaving a residual tar. The composition of a typical tar can vary somewhat depending on the manufacturing process employed. Prior to the present invention there have been unsuccessful attempts to solvate and/or fluidize TDI tar using a variety of aromatic and non-aromatic solvents and plasticizers in order to optimize the recovery of unreacted monomer as well as to facilitate the disposal of the residue tars.

U.S. Pat. No. 4,000,099 which issued on Dec. 26, 1976 to Makato Nemato et al discloses and claims an invention which employs a variety of materials to solvate tars with varying degrees of success, such as, dioctyl phthalate, dibutyl phthalate, aromatic high boiling neutral oils such as creosote oil, anthracene oil, pitch oil, xylene, ethyl acetate, butyl acetate, methyl ethyl ketone, isobutyl ketone, cellosolve acetate, and the like.

The method in U.S. Pat. No. 4,055,585, which issued on Oct. 25, 1977 to Mashahio Okamoto discloses another process which utilizes a variety of solvents including creosote oil, anthracene oil, pitch oil, methyl naphthalene oil, crystal-freed naphthalene oil, absorbing oil, washing oil, and hydrogenated cracked gasoline with a boiling point above 200° C.

In U.S. Pat. No. 4,834,003, which issued on May 30, 1989 to Arthur Reische a method to solvate and/or fluidized TDI tars is set forth which also employs a wide variety of solvents including methylene chloride, cyclohexane, toluene, xylene, dichlorobenzene and dimethyl formamide.

Another method for solvating or fluidizing the TDI tars is in basis of the invention disclosed and claimed in U.S. Pat. No. 4,506,040, which issued Mar. 19, 1985 to Maurice Raes. In this patent a variety of organic compounds was disclosed and included such compounds as monochlorobenzene, o-dichlorobenzene, p-chlorobenzene, cellosolve acetate, acetone, tetrahydronaphthalene, benzene, toluene, xylene, chlorotoluene, trichlorobenzene, cyclohexane, kerosene, carbon tetrachloride, and trichloroethylene.

In a more recent invention as described in U.S. Pat. No. 5,216,042, which issued Jun. 1, 1993 to Rory Daussin, numerous compounds were described as useful for this application and included among others such compounds as orthodichlorobenzene, toluene, benzene, nitrobenzene, anisole, xylene, monochlorobenzene and the like.

In each of these patents, the solvents or oils described have initial boiling points (IPB) below the final boiling points (FBP) of the TDI monomer. The overlapping of their distillation ranges with the TDI monomer makes separation of uncontaminated TDI monomer from the TDI tar difficult when using conventional distillation equipment.

Hence, prior to the present invention there has been no economic or practical method of liquefying residual tar bottoms from conventionally manufactured TDI monomers. Such tar bottoms are composed of various isomers and TDI oligomers and polymers produced in situ in the tar. Raising the temperature to lower the TDI tar's viscosity can result in decomposition of the tar and potentially dangerous off-gassing or cause the tar to solidify if the temperature and flow rates are not carefully controlled. Disposal of TDI tar material ranges from deep well disposal techniques to controlled burial in approved land fills to incineration, with incineration being the preferred method. TDI tar is expensive and difficult to incinerate for two reasons: first, the NCO reactive group itself is difficult to combust and second, the tar tends to solidify on the injector nozzle and/or drop to the incinerator bottom resulting in handling problems. Both conditions being undesirable.

Depending on their particular process, TDI is generally a complex mixture of oligomer compounds consisting of various molecular weights of, but not limited to, urea, biuret, uetidione, isocyanate, diisocyanate, carbodiimide, uethoneimine, and alkyl benzimidazolone groups. As produced TDI tar appears as a brittle dark brown/black solid at room temperature with an approximate softening point of 200° C. Above this temperature the TDI tar becomes a viscous liquid. Currently, produced TDI tar has a TDI monomer content ranging from 10 to 30 weight percent. The producer of TDI monomer retains TDI monomer in the tar to help fluidize the TDI tar for pumpability and transport. There is a continual danger of stripping too much TDI monomer from the TDI tar causing transport lines and vapor/liquid separation equipment to plug. This situation causes undesirable down time while the plug is cleared. The TDI monomer retained in the TDI tar is considered by the industry to be an undesirable but necessary product loss. The prior patents cited above, show that many substances have been examined and all have been found to be commercially deficient.

Accordingly, one or more of the following objects will be achieved by the practice of this invention. It is an object of this invention to provide a fluidizer composition for solvating TDI tar. Another object of this invention is to provide a fluidizer composition which can be employed to increase the recovery of the TDI monomer used to keep the tar fluid. Another object of this invention is to provide a method for fluidizing TDI tars formed during the preparation of TDI monomer. Another object is to provide a process which not only increases the recovery of the TDI monomer, but aids in facilitating the disposal of residual tar products resulting from TDI monomer synthesis. These and other objects will be readily apparent to those skilled in the art in light of the teachings herein set forth.

### SUMMARY OF THE INVENTION

This invention relates to its composition of a fluidizer for TDI tars and enhanced monomer recovery. The fluidizer composition is comprised of an aprotic, weakly nucleophilic, complex mixture of strongly aromatic oils, the mixture consists essentially of isomers of 2, 3 and 4 condensed aromatic rings with alkyl and naphthalenic substitutes, the mixture having an initial boiling point of no less than 288° C. and wherein the mixture is essentially free of moieties which are reactive with components of TDI monomer and tar formed therein.

The invention has an aromatic content as determined by ASTM D 2007 of not less than 95%.

This invention is fully compatible with typically produced TDI tars. The tar thereafter remains in solution at processing temperatures and down to room temperature. This feature allows the TDI monomer producer to readily pump the lower viscosity TDI tar for incineration or other disposal minimizing the amount of TDI monomer retained in the tar.

The unique solvency of the fluidizer composition, which allows it to reduce the TDI tar's viscosity, also allows the TDI monomer producer to recover more TDI monomer than had traditionally been left in the tar to keep the TDI tar's viscosity pumpable. The initial boiling point (IBP) of the fluidizer composition is set well above the Final Boiling Point (FBP) of TDI monomer to enhance separation of the TDI monomer from the TDI tar while maintaining a pumpable viscosity for the TDI tar.

The present invention is also unique in that the fluidizer is designed without reactive moieties that could react with the TDI monomer forming undesirable by-products and reducing product yield. It should also be noted that the fluidizer remains stable in the highly acidic TDI tar. This acidity is due primarily to the high levels of hydrolysable chlorides contained in the TDI tar. Accordingly, the fluidizer helps with the rheology and combustion of the TDI tar and improves handling in or at the incinerator. The use of the fluidizer composition also helps to prevent the tendency of TDI tars to irreversibly solidify when held at processing conditions for extended periods.

### DESCRIPTION OF THE PREFERRED EMBODIMENTS

Analysis of the prior art, relevant to engineering design principles, at presently installed TDI manufacturing facilities reveals that a superior fluidizer to TDI monomer must possess all of the following attributes:
1. Non reactive with TDI monomer or reactive chemicals contained in the co-produced tar.
2. Easily separable from the TDI monomer by vapor/liquid phase separation.
3. Physically compatible with the tar, i.e. forms a single, homogenous phase with the tar or plant operating conditions.
4. Low liquid phase viscosity to reduce the amount of fluidizer required to meet process viscosity constraints.
5. More economic than TDI monomer.
6. Easily combustible by augmenting the tar's combustion.
7. Remains stable in the acidic, hydrolyzable chloride environment of a typical TDI tar.

One embodiment of the present invention therefore provides a unique, aprotic, weakly nucleophilic aromatic oil mixture composition which possess the above attributes and is useful in fluidizing typical diisocyanate tar material (TDI tar) to improve TDI monomer recovery and to make the TDI manufacturing process more efficient. The aromatic oil employed as the fluidizer has a unique composition consisting of primarily 2, 3, 4 aromatic rings with a variety of alkyl and naphthenic side chains.

This aromatic oil mixture has an initial boiling point of not less than 288° C. To facilitate removal of the TDI monomer retained in the TDI tar and to insure its retention in the TDI tar fraction during separation and TDI monomer recovery. This aromatic oil has been produced with virtually no reactive moieties such as sulfur compounds, nitrogen compounds, organic acids, alkaline metal salts or proton donating species that could react with the TDI monomer to reduce production yields.

This aromatic oil, which is employed in the fluidizer of the present invention is a particular fraction, having a boiling point of not less than 288° C., obtained by fractional distillation of commercially available aromatic oils sold by major oil companies. For example, Exxon Mobil Chemical Company has available an aromatic oil under its trade name Development Fluid 157.

A second embodiment of this invention is the use of the fluidizer composition in enhancing the recovery of unreacted TDI monomer. The fluidizer is added to one or more of the recovery stage of a conventional reactor where unreacted monomer is separated from the tars formed during the preparation of TDI monomer.

The invention is employed in an amount which is effective to fluidize the TDI tar bottoms. The actual amount will vary depending upon several factors including the type of reactor itself, reaction rates, flow conditions and the like. In practice, the amount of fluidizer employed can range from about 5 to about 50 weight percent based on the weight of expected tar formed in the reaction.

The following Examples are illustrative of the invention:

1) The stability of the invention in boiling water was studied. A 50/50 by weight mixture of the invention and tap water was brought to a boil (100° C.) for 4 hours while the mixture was continuously stirred with a magnet stirrer. The 50/50 weight ratio was held constant over the 4 hours by monitoring the level of liquid and periodically replacing the evaporated water. The mixture was allowed to cool to room temperature and phase separate overnight. The refractive index (RI) of each phase was recorded. It should be noted that measuring the refractive index of the invention is left to the skill and special techniques of the analytical chemist performing the measurement. This data shows that the RI of both phases were unchanged indicating the invention is stable in boiling water:

Refractive Index @25° C.

| | | 4 hours @100° C. |
|---|---|---|
| Test Sample | Initial data @RT | Cooled overnight to RT |
| Water | 1.3337 | 1.3337 |
| Invention | 1.6437 | 1.6437 |

2) It was then necessary to determine the stability of the invention in a highly acidic environment to simulate the hydrolzable chloride environment of the TDI tar itself. The same 50/50 by weight water/Invention mixture used in example #1 was again subjected to boiling for another 4 hours but now with the addition of 7.5 pph concentrated HCl (37.4%, 12.1 Normal). Again, the 50/50 weight ratio was held constant over the 4 hours by monitoring the level of liquid and periodically replacing the evaporated water. This mixture was then allowed to cool overnight to room temperature and refractive index measured. The RI shows the invention to be essentially unchanged.

| | Refractive Index @25° C. |
|---|---|
| | 4 hours @100° C. |
| Test Sample | Cooled overnight to RT |
| Water | 1.3396 |
| Invention | 1.6447 |

3) It was then necessary to compare the ease of TDI monomer extraction from the tar with the invention and without. The apparatus used to quantitatively determine the amount of TDI monomer extracted from the TDI tar was a round bottom flask, under vacuum connected to three vapor traps. The first trap was a cold finger, ice water/salt trap maintained at −9° C. that collected the bulk of the monomer distilled away from the tar. A second cold finger, ice water/salt trap, again maintained at −9° C. collected a trace amount of monomer with a third acetone/dry ice trap maintained at −65° C. collected any residual monomer vapor. A vacuum of 29 inches of mercury was applied before the tar was heated. For purposes of this example, 15% by weight of the invention was added to one sample of the tar and these results were compared to the tar with no addition of the invention. Care was taken to avoid carryover of the invention oil by limiting the maximum temperatures of the TDI monomer tar/oil blend to 20° C. below the IBP of the invention at the pressure noted above.

| Sample | Total TDI monomer | Initial boiling | | Polymerization |
|---|---|---|---|---|
| Description | extracted from the tar | temperature¹ | | temperature² |
| 1) TDI tar (neat) | 5-8% | 121-127° | C. | 160-167° C. |
| 2) TDI tar with 15% by wt. | 12-14% | 104° | C. | 185-190° C. |
| Of the invention | | | | |

¹Of the TDI monomer in the tar
²The temperature at which the tar polymerized solid

This data demonstrates clearly that the invention allows the TDI monomer producer to extract more monomer from the tar at a low temperature with a higher temperature limit before the tar polymerizes.

4) The viscosity reduction potential of the invention shows the invention's ability to lower the TDI tar viscosity was measured and compared to the TDI tar neat at 100° C.:

| | |
|---|---|
| a) Neat TDI tar | 974 cps |
| b) 15% addition of Invention to TDI tar | 322 cps |

A 15% by weight addition of the invention lowered the TDI. tar's viscosity by 200%
5) The solubility of the invention in typical TDI tar was determined to be excellent. The invention started going into solution with the TDI tar at 43°-49° C. and is soluble in all portions. The appearance of the TDI tar with 15% of the invention was that of a clear, dark red/yellow, single-phase solution. This solution is stable at room temperature for an extended period of two weeks. Viscosity stability of the invention in the TDI tar was also maintained over this same two-week period.

It is therefore evident that this invention fluidizes these TDI oligomer tars replacing a significant amount of the TDI monomer itself which has been historically used as the fluidizer in these TDI tars. The invention allows the toluene diisocyanate manufacturer to recover more TDI monomer thereby improving operating efficiencies and product yield and aids in the incineration or other disposal methods for the tars.

Although the invention has been illustrated by the foregoing examples it is not to be construed as being limited to the materials employed therein. Rather the invention is directed to the generic area as hereinbefore disclosed. Various modifications and embodiments thereof can be made without departing from the spirit or scope thereof.

1. A fluidizer composition for liquefying tar bottoms from conventionally manufactured toluene diisocyanate monomer in order to increase the recovery of the expensive unreacted toluene diisocyanate monomer as well as facilitate the disposition of the tar bottoms, said fluidizer composition comprised of:
an aprotic, weekly nucleophilic, complex mixture of strongly aromatic oils, the mixture consists essentially of isomers of 2, 3and 4 condensed aromatic rings with alkyl and naphthenic substituents, the mixture having a boiling point of no less than about 288° C.,and wherein the mixture is essentially free of moieties which are reactive with components of the reactants and tars formed therein.

2. The fluidizer composition of claim 1 wherein said mixture is essentially free of moieties selected from the group consisting of sulfur compounds, nitrogen compounds, organic acids, alkaline metal salts and proton donating species that could react with the TDI monomer to reduce production yields.

3. The fluidizer composition of claim 1 which is easily separable from toluene diisocyanate by vapor/liquid phase separation.

4. The fluidizer composition of claim 1 which forms a single, homogenous phase with tars at plant operating conditions.

5. The fluidizer composition of claim 1 which has an aromatic content of not less than 95 percent as determined by ASTM D 2007.

7. The fluidizer composition of claim 1 which has a viscosity of not more than 25 centestokes at 40° C.

8. The fluidizer composition of claim 1 which has a specific gravity of from about 1.02 to about 1.09 at 15.5° C.

9. Tar bottoms formed by the conventional manufacturing method for making TDI monomer which have been liquefied by addition of a liquefying amount of the fluidizer of claim 1.

10. In a method for the recovery of unreacted toluene diisocyanate used in the manufacture of toluene diisocyanate monomer, the improvement which comprises introducing into said method an effective liquefying amount of the fluidizer composition of claim 1.
